(19) United States
(12) Patent Application Publication
(10) Pub. No.: US 2011/0080391 A1
(43) Pub. Date: Apr. 7, 2011

(54) DISPLAY DEVICE

(76) Inventors: Christopher Brown, Oxford (GB); Hiromi Katoh, Osaka (JP)

(21) Appl. No.: 12/995,853

(22) PCT Filed: Apr. 28, 2009
(86) PCT No.: PCT/JP2009/058319

§ 371 Date: Dec. 2, 2010

(30) Foreign Application Priority Data
Jun. 3, 2008 (JP) 2008-146073

(51) Int. Cl. G09G 3/36; G09G 5/00

(52) U.S. Cl. 345/207; 345/87

(57) ABSTRACT

A display device includes a photosensor in a pixel region (1) of an active matrix substrate (100). The photosensor is provided with a photodetection element (D1) that receives incident light; a capacitor (C2), one electrode of which is connected to the photodetection element (D1), that accumulates output current from the photodetection element (D1); reset signal wiring (RST) that supplies a reset signal to the photosensor; readout signal wiring (RWS) that supplies a readout signal to the photosensor; and a sensor switching element (M2) that, in accordance with the readout signal, reads out the output current accumulated in the capacitor (C2) from when the reset signal is supplied until when the readout signal is supplied. Conductive wiring (ML) is provided along readout wiring (SLr) that is for reading out the output current, the conductive wiring (ML) being connected to neither the photodetection element (D1) in the pixel region nor a pixel switching element (M1) of the pixel region.

### TECHNICAL FIELD

The present invention relates to a display device with a photosensor having a photodetection element such as a photodiode or phototransistor, and in particular to a display device that includes a photosensor inside a pixel region.

### BACKGROUND ART

Conventionally, there has been proposed a display device with a photosensor that, due to including a photodetection element such as a photodiode inside a pixel, can detect the brightness of external light and pick up an image of an object that has come close to the display. Such a display device with a photosensor is envisioned to be used as a bidirectional communication display device or display device with a touch panel function.

In a conventional display device with a photosensor, when using a semiconductor process to form known constituent elements such as signal lines, scan lines, TFTs (Thin Film Transistor), and pixel electrodes on an active matrix substrate, a photodiode or the like is simultaneously formed on the active matrix substrate (see JP 2006-3857A, and “A Touch Panel Function Integrated LCD Including LTPS A/D Converter”, T. Nakamura et al., SID 05 DIGEST, pp. 1,054-1,055, 2005).

FIG. 9 shows an example of a conventional photosensor formed on an active matrix substrate (see WO 2007/145346 and WO 2007/145347). The conventional photosensor shown in FIG. 9 is configured by a photodiode D1, a capacitor C2, and a transistor M2. The anode of the photodiode D1 is connected to wiring RST, which is for supplying a reset signal. The cathode of the photodiode Dl is connected to one electrode of the capacitor C2 and the gate of the transistor M2. The drain of the transistor M2 is connected to wiring VDD, and the source is connected to wiring OUT. The other electrode of the capacitor C2 is connected to wiring RWS, which is for supplying a readout signal.

In this configuration, the reset signal and the readout signal are respectively supplied to the wiring RST and the wiring RWS at predetermined times, thus enabling obtaining sensor output V_{PIX} that is in accordance with the amount of light received by the photodiode D1. A description is now given of operations of the conventional photosensor shown in FIG. 9, with reference to FIG. 10. Note that the reset signal at low level (e.g., −4 V) is shown as V_{RST.L}, the reset signal at high level (e.g., 0 V) is shown as V_{RST.H}, the readout signal at low level (e.g., 0 V) is shown as V_{RWS.L}, and the readout signal at high level (e.g., 8 V) is shown as V_{RWS.H}.

First, when the high level reset signal V_{RST.H} is supplied to the wiring RST, the photodiode D1 becomes forward biased, and a potential V_{INT} of the gate of the transistor M2 is expressed by Expression (1) below.

V_{INT}=V_{RST.H}−V_{F} (1)

In Expression (1), V_{F} is the forward voltage of the photodiode D1, ΔV_{RST} is the height of the reset signal pulse (V_{RST.H}−V_{RST.L}), and C_{PD} is the capacitance of the photodiode D1. C_{T} is the sum of the capacitance of the capacitor C2, the capacitance C_{PD} of the photodiode D1, and a capacitance C_{TFT} of the transistor M2. Since V_{INT} is lower than the threshold voltage of the transistor M2 at this time, the transistor M2 is in a non-conducting state in the reset period.

Next, the reset signal returns to the low level V_{RST.L} (time t=RST in FIG. 10), and thus the photocurrent integration period (period T_{INT} shown in FIG. 10) begins. In the integration period, a photocurrent that is proportionate to the amount of incident light received by the photodiode D1 flows to the capacitor C2, and causes the capacitor C2 to discharge. Accordingly, the potential V_{INT} of the gate of the transistor M2 when the integration period ends is expressed by Expression (2) below.

V_{INT}=V_{RST.H}−V_{F}−ΔV_{RST}·C_{PD}/C_{T}−I_{PHOTO}·T_{INT}/C_{T} (2)

In Expression (2), I_{PHOTO} is the photocurrent of the photodiode D1, and T_{INT} is the length of the integration period. In the integration period as well, V_{INT} is lower than the threshold voltage of the transistor M2, and therefore the transistor M2 is in the non-conducting state.

When the integration period ends, the readout signal RWS rises at a time t=RWS shown in FIG. 10, and thus the readout period begins. Note that the readout period continues while the readout signal RWS is at high level. Here, the injection of charge into the capacitor C2 occurs. As a result, the potential V_{INT} of the gate of the transistor M2 is expressed by Expression (3) below.

V_{INT}=V_{RST.H}−V_{F}−ΔV_{RST}·C_{PD}/C_{T}−I_{PHOTO}·T_{INT}/C_{T}+ΔV_{RWS}·C_{INT}/C_{T} (3)

ΔV_{RWS} is the height of the readout signal pulse (V_{RWS.H}−V_{RWS.L}). Accordingly, since the potential V_{INT} of the gate of the transistor M2 becomes higher than the threshold voltage, the transistor M2 enters the conducting state and functions as a source follower amplifier along with a bias transistor M3 provided at the end of the wiring OUT in each column. In other words, the sensor output voltage V_{PIX} from the transistor M2 is proportionate to the integral value of the photocurrent of the photodiode D1 in the integration period.

Note that in FIG. 10, the broken line waveform indicates change in the potential V_{INT} in the case where a small amount of light is incident on the photodiode D1, and the solid line waveform indicates change in the potential V_{INT} in the case where external light has incidented on the photodiode D1. In FIG. 10, ΔV is a potential difference proportionate to the amount of light that has incidented on the photodiode D1.

### DISCLOSURE OF INVENTION

### Problem to be Solved by the Invention

However, in the above-described conventional photosensor shown in FIG. 9, in actuality a parasitic capacitor C_{P} exists between a source line and various types of lines with which it intersects, as shown in FIG. 9. For this reason, the photocurrent output from the transistor M2 is charged into such parasitic capacitors C_{P} as well. The rise in the sensor output voltage V_{PIX} is therefore not sufficiently steep, as shown by the solid line in FIG. 11. Accordingly, there are cases where the sensor output voltage V_{PIX} does not reach the correct voltage (broken line in FIG. 11) that is originally to be reached in the readout period (while the readout signal RWS is at high level).

This problem is particularly remarkable in a display device that has a large number of pixels. The reason for this is that with a display device that has a large number of pixels, the length of the readout period per pixel is short, and furthermore the number of source lines is large, and therefore the total capacitance of the parasitic capacitors C_{P} is inevitably large.

Alternatively, in the case where the transistor M2 is an element that has a low current drive capability, such as an amorphous silicon TFT, there is the problem that a sufficient current for charging the parasitic capacitors C_{P} of the source lines cannot be supplied.

In light of the above-described problems, an object of the present invention is to provide a display device with a photosensor in which the time required for reading sensor output from photosensors has been shortened.

### Means for Solving Problem

In order to address the above-described issues, a display device according to the present invention is a display device including a photosensor in a pixel region of an active matrix substrate, the photosensor being provided with: a photodetection element that receives incident light; a capacitor, one electrode of which is connected to the photodetection element, that accumulates output current from the photodetection element; reset signal wiring that supplies a reset signal to the photosensor; readout signal wiring that supplies a readout signal to the photosensor; and a sensor switching element that, in accordance with the readout signal, reads out the output current accumulated in the capacitor from when the reset signal is supplied until when the readout signal is supplied, wherein conductive wiring is provided along readout wiring that is for reading out the output current, the conductive wiring being connected to neither the photodetection element in the pixel region nor a pixel switching element of the pixel region.

### Effects of the Invention

The present invention enables providing a display device with a photosensor in which the time required for reading sensor output from photosensors has been shortened.

### BRIEF DESCRIPTION OF DRAWINGS

FIG. 1 is a block diagram showing a schematic configuration of a display device according to an embodiment of the present invention.

FIG. 2 is an equivalent circuit diagram showing a configuration of a pixel and a configuration of a column driver circuit in a display device according to Embodiment 1 of the present invention.

FIG. 3 is a timing chart showing various types of signals supplied to the display device according to Embodiment 1.

FIG. 4 is an equivalent circuit diagram showing a configuration of a pixel and a configuration of a column driver circuit in a display device according to Embodiment 2 of the present invention.

FIG. 5 is a waveform diagram showing a relationship between input signals (RST and RWS) and V_{INT} in a photosensor according to Embodiment 2.

FIG. 6 is an equivalent circuit diagram showing a configuration of a pixel and a configuration of a column driver circuit in a display device according to Embodiment 3 of the present invention. This circuit diagram shows an internal configuration of a sensor pixel readout circuit.

FIG. 7 is a waveform diagram showing a relationship between V_{INT} and various types of signals applied to a photosensor according to Embodiment 3.

FIG. 8 is a waveform diagram showing, as a comparative example, change in V_{INT} in the case where the drop in the potential of the reset signal RST was not steep in the configuration according to Embodiment 2.

FIG. 9 is an equivalent circuit diagram showing an exemplary configuration of a conventional photosensor.

FIG. 10 is a waveform diagram showing V_{INT} in the case where the reset signal RST and the readout signal RWS have been applied to the conventional photosensor.

FIG. 11 is a waveform diagram showing the condition in the conventional photosensor in which the photosensor output is not sufficient in the readout period due to parasitic capacitance.

### DESCRIPTION OF THE INVENTION

A display device according to an embodiment of the present invention is a display device including a photosensor in a pixel region of an active matrix substrate, the photosensor being provided with: a photodetection element that receives incident light; a capacitor, one electrode of which is connected to the photodetection element, that accumulates output current from the photodetection element; reset signal wiring that supplies a reset signal to the photosensor; readout signal wiring that supplies a readout signal to the photosensor; and a sensor switching element that, in accordance with the readout signal, reads out the output current accumulated in the capacitor from when the reset signal is supplied until when the readout signal is supplied, wherein conductive wiring is provided along readout wiring that is for reading out the output current, the conductive wiring being connected to neither the photodetection element in the pixel region nor a pixel switching element of the pixel region.

According to this configuration, the conductive wiring exhibits the function of shielding the readout wiring from the influence of parasitic capacitance. Accordingly, the parasitic capacitance in the vicinity of the readout wiring can be reduced, thereby shortening the time required for reading out sensor output from the photosensor. Also, since reading out sensor output requires only a short time, it is possible to realize a display device with a photosensor that has a large number of pixels.

In the above-described display device, it is preferable that a unity-gain amplifier that causes a potential of the conductive wiring to be the same as a potential of the readout wiring is connected to the conductive wiring. Also, an amplifier having a gain greater than 1 may be used in place of the unity-gain amplifier. According to these configurations, the parasitic capacitance between the conductive wiring and the readout wiring can be substantially eliminated, thus enabling further shortening the time required for reading out sensor output.

In the above-described display device, it is preferable that the readout wiring also serves as a source line that supplies an image signal to the pixel switching element of the pixel region. Reducing the amount of wiring enables improving the aperture ratio.

Also, in the above-described display device, the sensor switching element can be configured by an amorphous silicon TFT or a microcrystalline silicon TFT. In other words, the sensor switching element is not required to have a high drive capability in the above-described display device, and therefore instead of being limited to a polysilicon TFT having a high mobility, the sensor switching element can be formed by an amorphous silicon TFT or a microcrystalline silicon TFT. This enables inexpensively providing a display device with a photosensor.

In the above-described display device, besides a photodiode, a phototransistor can be used as the photodetection element. Also, this phototransistor can be realized by an amorphous silicon TFT or a microcrystalline silicon TFT. Also, a configuration is possible in which a gate and a source of the phototransistor are connected to the reset signal wiring. Alternatively, a configuration is possible in which the gate is connected to the reset signal wiring, and the source is connected to second reset signal wiring that causes a potential drop after the transistor has entered an off state. According to the latter configuration, it is possible to suppress a drop in the gate potential that occurs during a reset due to the bidirectional conductivity of the transistor, thus enabling providing a photosensor that has a wide dynamic range.

Furthermore, the above-described display device can be favorably implemented as a liquid crystal display device further including a common substrate opposing the active matrix substrate, and liquid crystal sandwiched between the active matrix substrate and the common substrate, but is not limited to this.

Below is a description of more specific embodiments of the present invention with reference to the drawings. Note that although the following embodiments show examples of configurations in which a display device according to the present invention is implemented as a liquid crystal display device, the display device according to the present invention is not limited to a liquid crystal display device, and is applicable to an arbitrary display device that uses an active matrix substrate. It should also be noted that due to having a photosensor, the display device according to the present invention is envisioned to be used as, for example, a display device with a touch panel that performs input operations by detecting an object that has come close to the screen, or a bidirectional communication display device that is equipped with a display function and an image capture function.

Also, for the sake of convenience in the description, the drawings that are referred to below show simplifications of, among the constituent members of the embodiments of the present invention, only relevant members that are necessary for describing the present invention. Accordingly, the display device according to the present invention may include arbitrary constituent members that are not shown in the drawings that are referred to in this specification. Also, regarding the dimensions of the members in the drawings, the dimensions of the actual constituent members, the ratios of the dimensions of the members, and the like are not shown faithfully.

### Embodiment 1

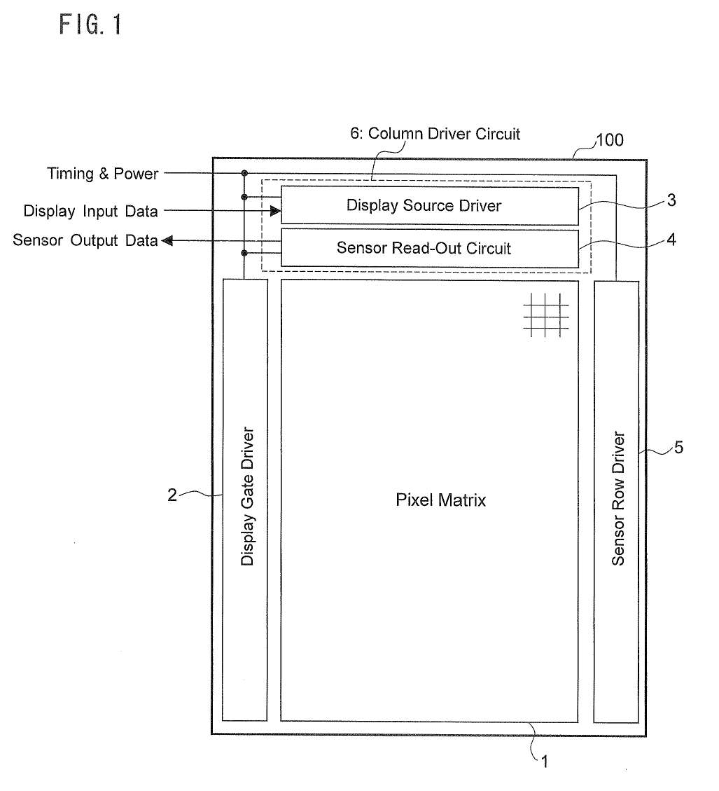

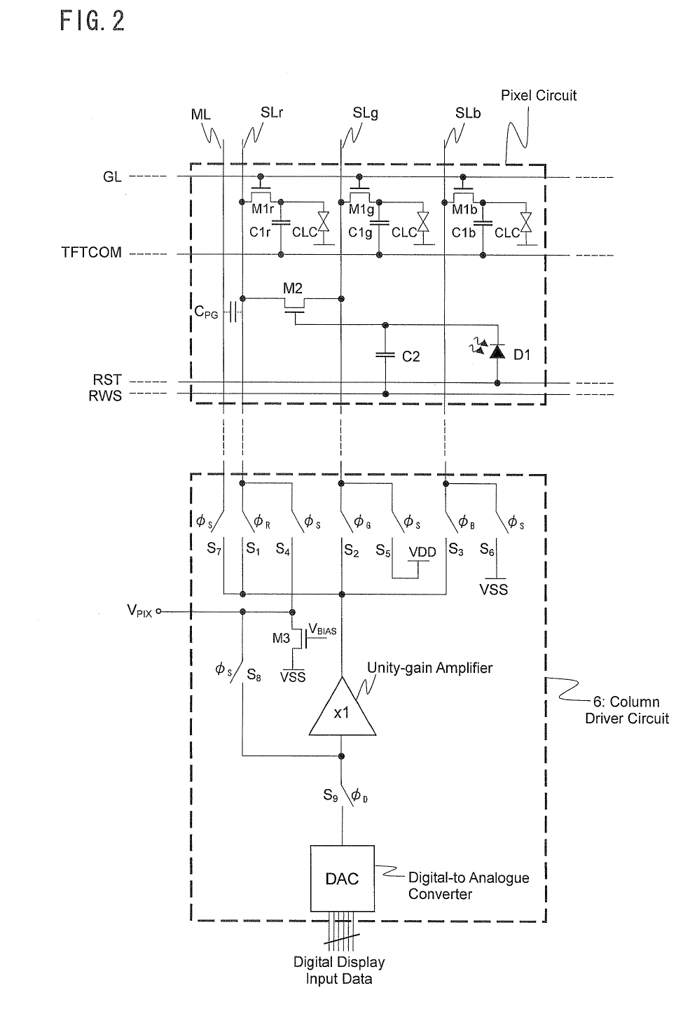

First, a configuration of an active matrix substrate included in a liquid crystal display device according to Embodiment 1 of the present invention is described with reference to FIGS. 1 and 2.

FIG. 1 is a block diagram showing a schematic configuration of an active matrix substrate 100 included in the liquid crystal display device according to Embodiment 1 of the present invention. As shown in FIG. 1, the active matrix substrate 100 includes at least a pixel region 1, a display gate driver 2, a display source driver 3, a sensor readout circuit 4, and a sensor row driver 5 on a glass substrate. The sensor readout circuit 4 and the sensor row driver 5 are realized as a column driver circuit 6. Note that although not shown in FIG. 1, a signal processing circuit for processing image signals picked up by a photodetection element (described later) in the pixel region 1 is connected to the active matrix substrate 100 via an FPC or the like.

Note that the above constituent members on the active matrix substrate 100 can also be formed monolithically on the glass substrate by a semiconductor process. Alternatively, a configuration is possible in which the amplifier and various drivers among the above constituent members are mounted on the glass substrate by COG (Chip On Glass) technology or the like. As another alternative, it is possible for at least a portion of the above constituent members shown on the active matrix substrate 100 in FIG. 1 to be mounted on the FPC. The active matrix substrate 100 is attached to a common substrate (not shown) that has a common electrode formed on the entire face thereof, and a liquid crystal material is enclosed in the gap therebetween.

The pixel region 1 is a region in which a plurality of pixels are formed in order to display an image. In the present embodiment, a photosensor for picking up an image is provided in each pixel in the pixel region 1. FIG. 2 is an equivalent circuit diagram showing the disposition of the pixels and photosensors in the pixel region 1 of the active matrix substrate 100. In the example in FIG. 2, each pixel is formed by three colors of picture elements, namely R (red), G (green), and B (blue), and one photosensor configured by a photodiode D1, a capacitor C2, and a thin film transistor M2 is provided in each of the pixels configured by these three picture elements. The pixel region 1 has pixels disposed in a matrix having M rows×N columns, and photosensors that are likewise disposed in a matrix having M rows×N columns. Note that as described above, the number of picture elements is M×3N.

For this reason, as shown in FIG. 2, the pixel region 1 has, as wiring for the pixels, gate lines GL and source lines SL that are disposed in a matrix. The gate lines GL are connected to the display gate driver 2. The source lines SL are connected to the display source driver 3. Note that the gate lines GL are provided in M rows in the pixel region 1. Hereinafter, the notation GLi (i=1 to M) is used when there is a need to distinguish between individual gate lines GL in the description. Meanwhile, three of the source lines SL are provided in each pixel in order to respectively supply image data to the three picture elements in each pixel as described above. The notations SLrj, SLgj, and SLbj (j=1 to N) are used when there is a need to distinguish between individual source lines SL in the description.

Thin film transistors (TFT) M1 are provided as switching elements for the pixels at intersections between the gate lines GL and the source lines SL. Note that in FIG. 2, the thin film transistors M1 provided in the red, green, and blue picture elements are noted as M1r, M1g, and M1b respectively. In each thin film transistor M1, the gate electrode is connected to one of the gate lines GL, the source electrode is connected to one of the source lines SL, and the drain electrode is connected to a pixel electrode that is not shown. Accordingly, as shown in FIG. 2, a liquid crystal capacitor CLC is formed between the drain electrode of each thin film transistor M1 and the common electrode (VCOM). Also, an auxiliary capacitor C1 is formed between each drain electrode and a TFTCOM.

In FIG. 2, the picture element driven by the thin film transistor M1r, which is connected to the intersection between one gate line GLi and one source line SLrj, is provided with a red color filter so as to correspond to that picture element, and red image data is supplied from the display source driver 3 to that picture element via the source line SLrj, and thus that picture element functions as a red picture element. Also, the picture element driven by the thin film transistor M1g, which is connected to the intersection between the gate line GLi and the source line SLgj, is provided with a green color filter so as to correspond to that picture element, and green image data is supplied from the display source driver 3 to that picture element via the source line SLgj, and thus that picture element functions as a green picture element. Furthermore, the picture element driven by the thin film transistor M1b, which is connected to the intersection between the gate line GLi and the source line SLbj, is provided with a blue color filter so as to correspond to that picture element, and blue image data is supplied from the display source driver 3 to that picture element via the source line SLbj, and thus that picture element functions as a blue picture element.

Note that in the example in FIG. 2, the photosensors are provided in the ratio of one per pixel (three picture elements) in the pixel region 1. However, the disposition ratio of the pixels and photosensors is arbitrary and not limited to merely this example. For example, one photosensor may be disposed per picture element, and a configuration is possible in which one photosensor is disposed for a plurality of pixels.

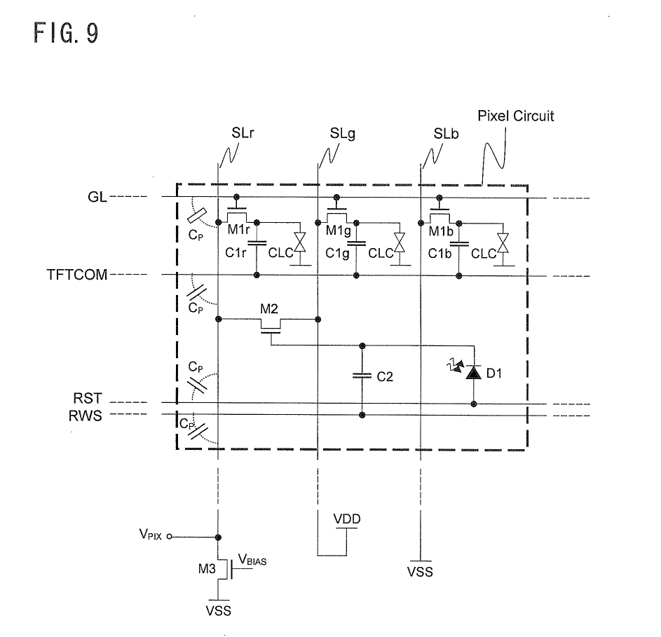

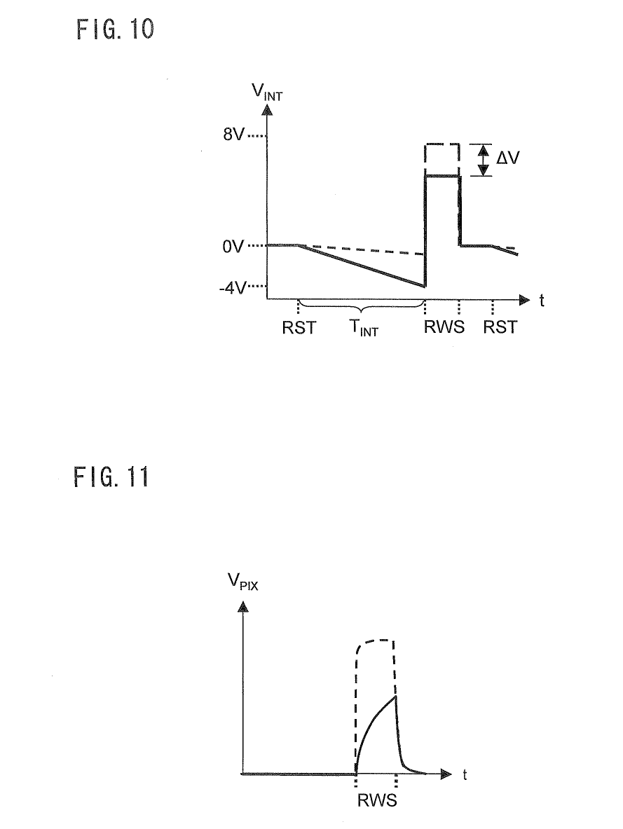

Also, as is evident from a comparison with FIG. 9, the display device of the present embodiment includes conductive wiring (hereinafter, referred to as a guard line) ML formed along the source line SLr in each pixel region. Note that the guard line ML is preferably formed as a conductive metal layer on the top layer of the source line. It should also be noted that the guard line ML may be formed by a transparent electrode (ITO), which is often used in liquid crystal display devices. Alternatively, the guard line ML can be formed using the same material as the source line, on the same plane as the source line (so as to be adjacent to the source line), and at the same time as the formation of the source line. This guard line ML has the effect of shortening the time required for reading out sensor output, which is described later.

The following describes the configuration of the column driver circuit 6 with reference to FIG. 2. As described above, the column driver circuit 6 includes the display source driver 3 for controlling pixel display, and the sensor readout circuit 4 for controlling the reading out of sensor output from photosensors. In the following description, constituent elements of the column driver circuit 6 are described without being divided between the display source driver 3 and the sensor readout circuit 4.

As shown in FIG. 2, the column driver circuit 6 includes a digital-to-analogue converter (DAC), a unity-gain amplifier, display sample gate switches S1, S2, and S3, sensor column switches S4, S5, and S6, a guard line switch S7, switches S8 and S9 for controlling input to the unity-gain amplifier, and a column bias transistor M3.

The DAC converts a digital input signal for display into analogue voltages that are written to pixels. The unity-gain amplifier (a) buffers the DAC output for driving the source lines in the pixel writing period, and (b) drives the guard line ML such that the voltage thereof has the same potential as the source line SLr in the sensor readout period. Note that the source line SLr functions as wiring for reading out sensor output from the transistor M2 in the sensor readout period.

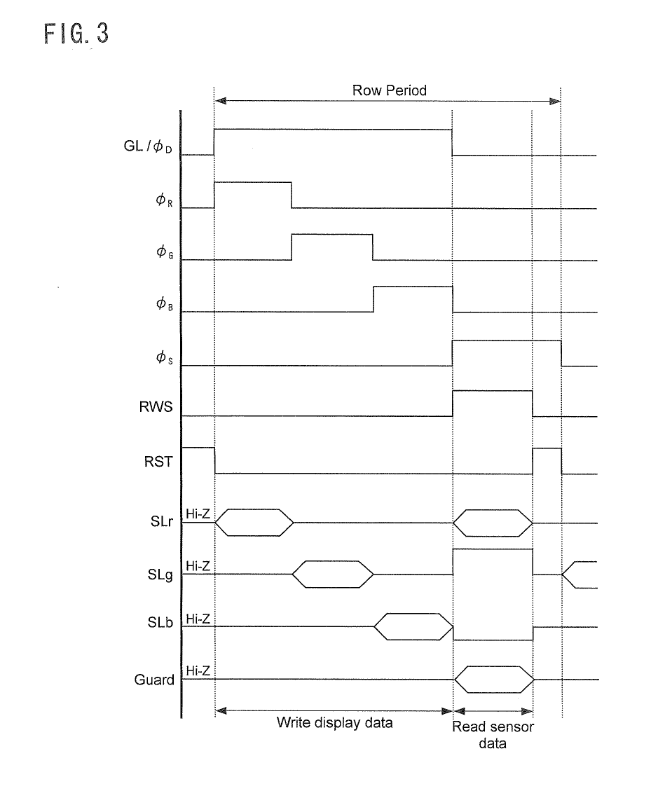

The display sample gate switches S1, S2, and S3 operate so as to connect the output of the unity-gain amplifier to the red, green, and blue column lines in φR, φG, and φB periods (see FIG. 3 described later) respectively.

The sensor column switch S4 operates so as to connect the sensor output readout wiring (SLr) to the transistor M2 in the sensor readout period (φS in FIG. 3). The sensor column switch S5 operates so as to connect the source line SLg to the VDD in the sensor readout period. The sensor column switch S6 operates so as to connect the source line SLb to the VSS in the sensor readout period.

The guard line switch S7 operates so as to connect the output of the unity-gain amplifier to the guard line ML in the sensor readout period. The switch S8 connects the input of the unity-gain amplifier to sensor output V_{PIX} in the sensor readout period. The switch S9 connects the input of the unity-gain amplifier to the DAC output in the pixel writing period (φD in FIG. 3).

The following describes operations of the circuit shown in FIG. 2, with reference to FIG. 3. In the pixel writing period (φD), input data for display corresponding to red, green, and blue pixels is sequentially given to input of the DAC in the periods φR, φG, and φB respectively. In this writing period, since the switch S9 is closed, the DAC generates analog output voltages corresponding to the digital data received as input. The unity-gain amplifier receives and buffers the analog output voltages generated by the DAC. In other words, the unity-gain amplifier has a function of outputting, to the output terminal, the same voltage as the voltage input to the input terminal. This is necessary for driving the source lines and the parasitic capacitance of the pixel. This enables the application of a desired voltage to the pixel while a desired source line is connected to the output of the unity-gain amplifier. The display sample gate switches S1 to S3 are selected in the order defined by the order of φR, then φG, and then φB, such that the source lines SLr, SLg, and SLb are sequentially connected to the unity-gain amplifier in accordance with the input data for display.

In the sensor readout period φS, the input of the unity-gain amplifier is connected to the sensor output V_{PIX} via the switch S8. The sensor column switches S4 to S6 are then switched on. While the readout signal RWS is at high level, the transistor M2 is in the on state and forms a source follower amplifier along with the column bias transistor M3. At this time, the value of the gate voltage of the transistor M2 and the sensor output V_{PIX} is in accordance with the amount of light detected by the photodiode D1.

In the configuration of the present embodiment, the guard line ML provided along the source line SLr shields the source line SLr from the influence of parasitic capacitance. Note that in this configuration, a relatively large parasitic capacitance C_{PG} exists between the source line SLr and the guard line ML. However, since the unity-gain amplifier drives the guard line ML so as to have the same potential as the source line SLr, it is not necessary to supply the transistor M2 with a current for charging the parasitic capacitance C_{PG}. This enables further shortening the time required for reading out sensor output, as well as has the benefit of not requiring the transistor M2 to have a high drive capability Accordingly, the transistor M2 is not limited to being a polysilicon TFT having a high mobility, and can be formed by an amorphous silicon TFT or a microcrystalline silicon TFT. Also, since reading out sensor output requires only a short time, it is possible to realize a display device with a photosensor that has a large number of pixels.

Although a configuration including a unity-gain amplifier has been described as an example in the present embodiment, depending on the case, it may be preferable to use an amplifier whose gain is greater than 1 in place of the unity-gain amplifier.

For example, letting Cp be the parasitic capacitance of the source line SL, Cg be the capacitance between the source line SL and the guard line ML, and Cs be the sample capacitance of the sensor pixel readout circuit, the amount of charge necessary for detection when the guard line ML is not provided is as shown below.

∫I dt=ΔQ=ΔV_{SL}(Cp+Cs)

(V_{SL}=potential of output from source line SL) [Math 1]

For this reason, if the result of the panel design is that Cs and Cg are far greater than Cp, it is sufficient for the gain to be 1, and therefore a unity-gain amplifier can be used.

Note that in this case, the following expression is established.

∫I dt=ΔQ≈ΔV_{SL}·Cs [Math 2]

On the other hand, even if the guard line ML is provided, there are cases where, depending on layout circumstances or the like, the value of Cp cannot possibly be ignored. In such cases, it is necessary for the gain to be greater than 1.

In other words, the following expression is established.

∫I dt=ΔQ=ΔV_{SL}(Cp+Cs)+(1−A)ΔV_{SL}·Cg=ΔV_{SL}(Cp+Cs+(1−A)·Cg) [Math 3]

Ideally, the following expression is established.

$$Cp + ( 1 - A ) \cdot Cg = 0 \\ A = \frac{Cp}{Cg} + 1 \qquad [ Math 4 ]$$

For example, if the parasitic capacitance Cp of the source line SL and the parasitic capacitance Cg between the source line SL and the guard line ML are approximately the same, it is necessary for the gain to be 2.

### Embodiment 2

Below is a description of a display device according to Embodiment 2 of the present invention. Note that the same reference numerals have been used for constituent elements that have functions likewise to those of the constituent elements described in Embodiment 1, and detailed descriptions thereof have been omitted.

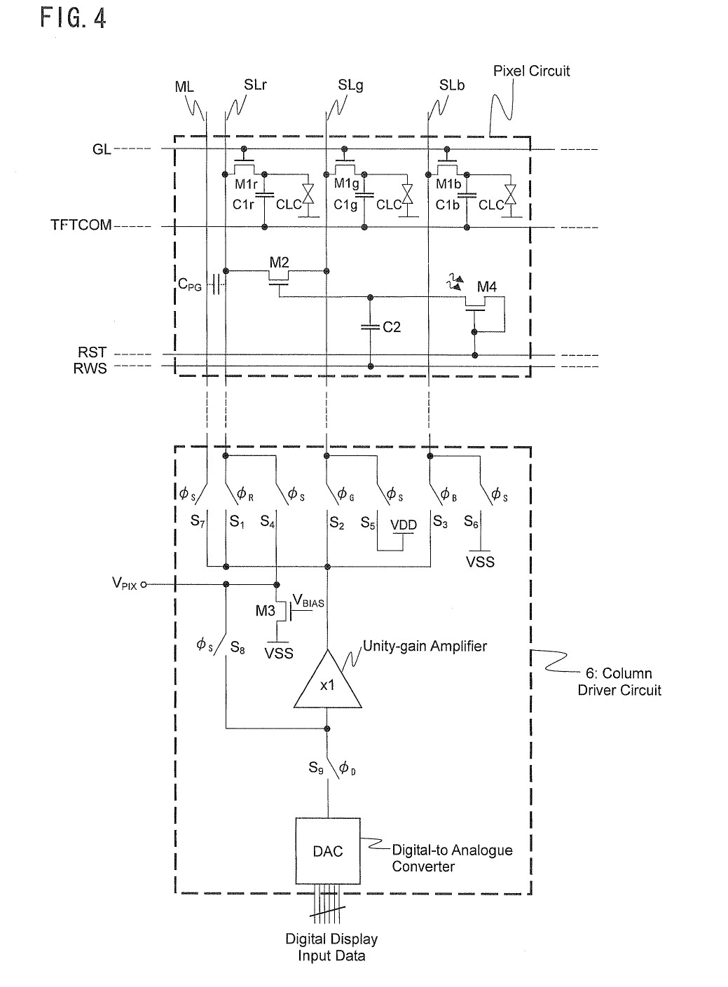

As shown in FIG. 4, the display device according to Embodiment 2 differs from Embodiment 1 in that a phototransistor M4 is included as the photodetection element of the photosensor in place of the photodiode D1. Note that the gate and the source of the phototransistor M4 are both connected to the reset wiring RST.

The phototransistor M4 is not limited to being a polysilicon TFT having a high mobility and can be an amorphous silicon TFT or a microcrystalline silicon TFT. In this case, if the transistor M2 is realized by an amorphous silicon TFT or a microcrystalline silicon TFT as described in Embodiment 1, the transistor M2 and the phototransistor M4 can be formed at the same time by the same semiconductor process. In other words, p+ doping and n+ doping cannot be performed on amorphous silicon and microcrystalline silicon, and therefore the number of processes increases when attempting to form a photodiode as the photodetection element in a photosensor. Accordingly, using the phototransistor M4 as the photodetection element enables forming the transistor M2 and the phototransistor M4 in the same process, which has the advantage of improving manufacturing efficiency.

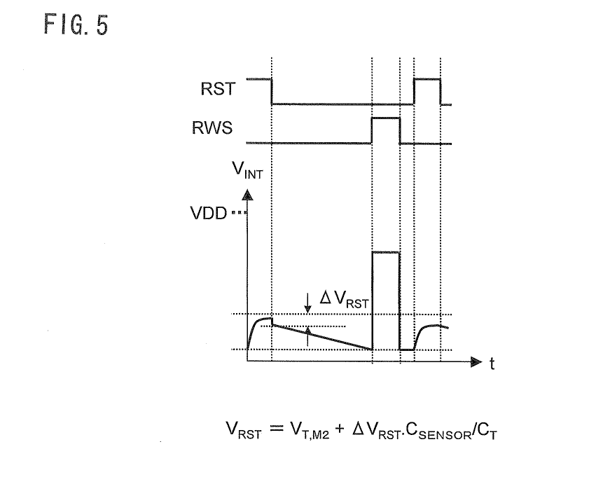

FIG. 5 is a waveform diagram showing operations of the photosensor according to the present embodiment. Note that the applied signals RWS, RST, and the like are similar to those shown in FIG. 3 in Embodiment 1. In the photosensor according to the present embodiment, when the reset signal RST is at high level, the potential V_{INT} of the gate electrode of the transistor M2 is expressed by Expression (4) below.

V_{INT}=V_{RST.H}−V_{T,M2}−ΔV_{RST}·C_{SENSOR}/C_{T} (4)

In Expression (4), V_{T,M2} is the threshold voltage of the transistor M2, ΔV_{RST} is the height of the reset signal pulse (V_{RST.H}−V_{RST.L}), and C_{SENSOR} is the capacitance of the phototransistor M4. C_{T} is the sum of the capacitance of the capacitor C2, the capacitance C_{SENSOR} of the phototransistor M4, and a capacitance C_{TFT} of the transistor M2. Since V_{INT} is lower than the threshold voltage of the transistor M2 at this time, the transistor M2 is in a nonconducting state in the reset period.

Next, the reset signal returns to the low level V_{RST.L}, and thus the photocurrent integration period begins. In the integration period, a photocurrent that is proportionate to the amount of incident light received by the phototransistor M4 flows to the capacitor C2, and causes the capacitor C2 to discharge. Accordingly, the potential V_{INT} of the gate of the transistor M2 when the integration period ends is expressed by Expression (5) below.

V_{INT}=V_{RST.H}−V_{T,M2}−ΔV_{RST}·C_{SENSOR}/C_{T}−I_{PHOTO}·T_{INT}/C_{T} (5)

In Expression (5), I_{PHOTO} is the photocurrent of the phototransistor M4, and T_{INT} is the length of the integration period. In the integration period as well, V_{INT} is lower than the threshold voltage of the transistor M2, and therefore the transistor M2 is in the non-conducting state.

When the integration period ends, the readout signal RWS rises, and thus the readout period begins. Note that the readout period continues while the readout signal RWS is at high level. Here, the injection of charge into the capacitor C2 occurs. As a result, the potential V_{INT} of the gate of the transistor M2 is expressed by Expression (6) below.

V_{INT}=V_{RST.H}−V_{T,M2}−ΔV_{RST}−C_{SENSOR}/C_{T}−I_{PHOTO}·T_{INT}/C_{T}+ΔV_{RWS}·C_{INT}/C_{T} (6)

ΔV_{RWS} is the height of the readout signal pulse (V_{RWS.H}−V_{RWS.L}). Accordingly, since the potential V_{INT} of the gate of the transistor M2 becomes higher than the threshold voltage, the transistor M2 enters the conducting state and functions as a source follower amplifier along with a bias transistor M3 provided at the end of the wiring OUT in each column. In other words, the sensor output voltage V_{PIX} from the transistor M2 is proportionate to the integral value of the photocurrent of the phototransistor M4 in the integration period.

As described above, the present embodiment enables obtaining photosensor output similarly to Embodiment 1 even when the phototransistor M4 is used in place of a photodiode as the photodetection element of a photosensor. Also, in particular, forming the transistor M2 and the phototransistor M4 from an amorphous silicon TFT or a microcrystalline silicon TFT has the advantage of improving manufacturing efficiency, and furthermore enabling more inexpensive manufacturing than when using polysilicon.

### Embodiment 3

Below is a description of a display device according to Embodiment 3 of the present invention. Note that the same reference numerals have been used for constituent elements that have functions likewise to those of the constituent elements described in Embodiments 1 and 2, and detailed descriptions thereof have been omitted.

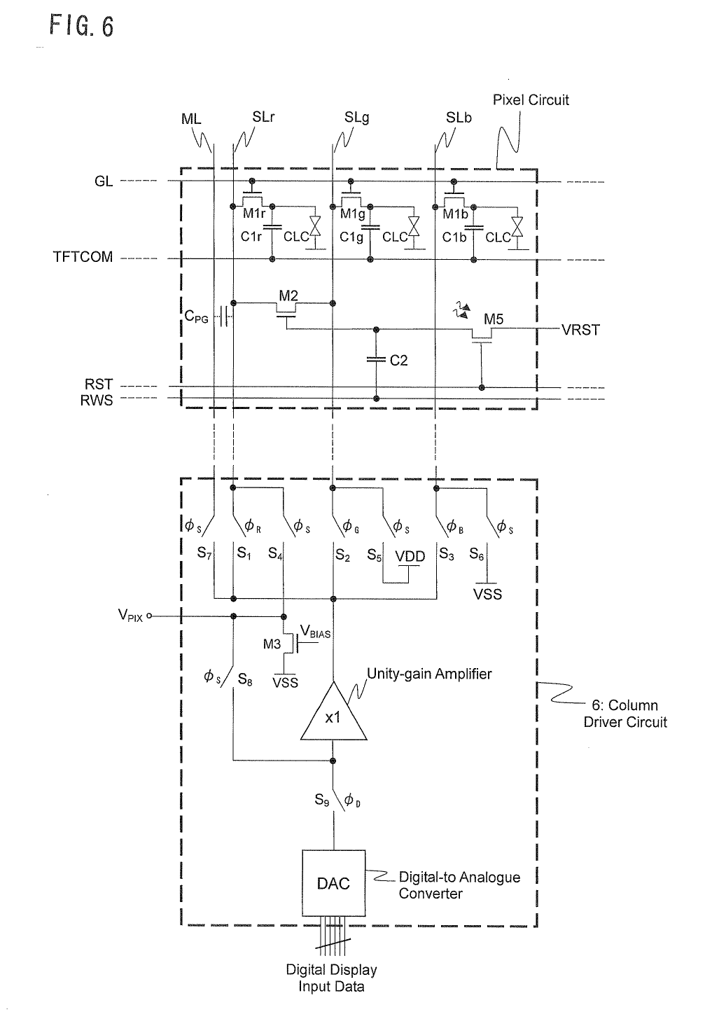

As shown in FIG. 6, the display device according to Embodiment 3 differs from Embodiment 2 in that a phototransistor M5 is included as the photodetection element of the photosensor in place of the phototransistor M4 described in Embodiment 2. The phototransistor M5 is the same as the phototransistor M4 in that the gate is connected to the reset wiring RST, but differs from the phototransistor M4 in that the source is connected to wiring for supplying a second reset signal VRST that is different from the reset signal RST.

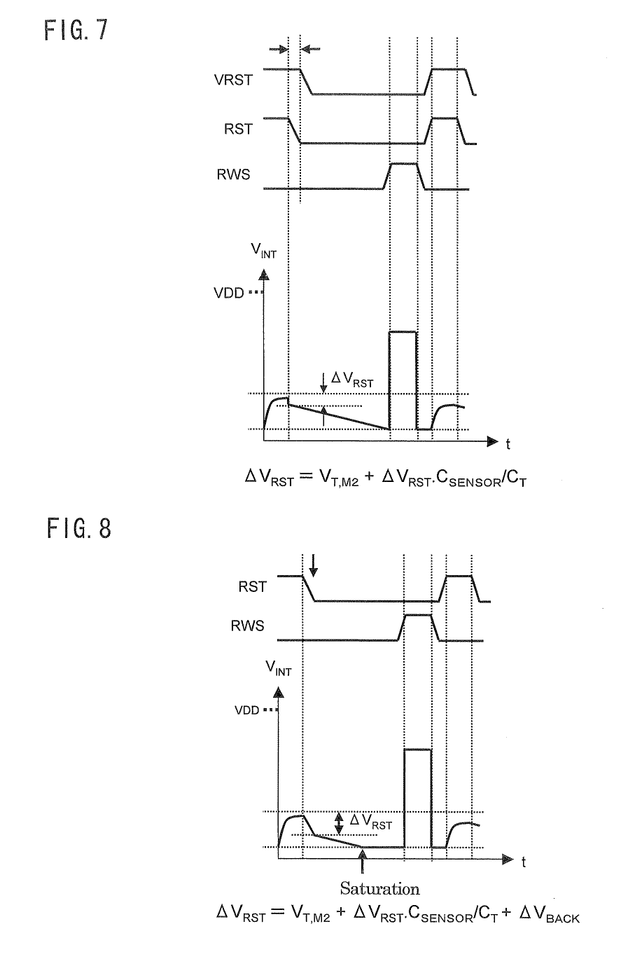

A description is now given of operations of the photosensor according to the present embodiment with reference to FIGS. 7 and 8. FIG. 7 is a waveform diagram showing the relationship between V_{INT} and various types of signals applied to the photosensor according to the present embodiment. FIG. 8 is a waveform diagram showing, as a comparative example, change in V_{INT} in the case where the drop in the potential of the reset signal RST was not steep in the configuration according to Embodiment 2.

As shown in FIG. 8, in the case where the drop in the potential of the reset signal RST in the configuration according to Embodiment 2 was not steep, the potential V_{INT} of the gate electrode of the transistor M2 falls a substantial amount (ΔV_{BACK} shown in FIG. 8) in the potential drop period of the reset signal RST. This reason for this is that the phototransistor M4 has bidirectional conductivity unlike a photodiode. In this case, the dynamic range of the pixel is reduced by an amount commensurate to the drop ΔV_{BACK}, thus causing the problem of saturation by a small amount of light.

In the configuration according to the present embodiment, in order to address this problem, separate reset signals RST and VRST are respectively applied to the gate and source of the phototransistor M5 as described above. As shown in FIG. 7, the drop in the potential of the second reset signal VRST applied to the source of the phototransistor M5 begins once the reset signal RST is completely at low level, that is to say, once the phototransistor M5 has switched to the off state. Accordingly, as shown by a comparison of FIGS. 8 and 7, the drop in the potential V_{INT} (ΔV_{BACK}) seen in FIG. 8 does not occur in the configuration of the present embodiment shown in FIG. 7, thus enabling obtaining substantially the same sensor performance as in the case of using a photodiode as the photodetection element.

Although the present invention has been described based on Embodiments 1 to 3, the present invention is not limited to only the above-described embodiments, and it is possible to make various changes within the scope of the invention.

For example, in the exemplary configurations given in Embodiments 1 to 3, the wiring VDD, VSS, and OUT connected to the photosensor are also used as source wiring SL. This configuration has the advantage that the pixel aperture ratio is high. However, a configuration is possible in which the wiring VDD, VSS, and OUT for the photosensor is provided separately from the source wiring SL. In this case, forming the guard line ML along the wiring OUT for photosensor output provided separately from the source wiring SL enables obtaining effects similar to those of Embodiments 1 to 3 described above.

### INDUSTRIAL APPLICABILITY

The present invention is industrially applicable as a display device having a photosensor in a pixel region of an active matrix substrate.

1. A display device comprising a photosensor in a pixel region of an active matrix substrate, the photosensor being provided with:
a photodetection element that receives incident light;
a capacitor, one electrode of which is connected to the photodetection element, that accumulates output current from the photodetection element;
reset signal wiring that supplies a reset signal to the photosensor;
readout signal wiring that supplies a readout signal to the photosensor; and
a sensor switching element that, in accordance with the readout signal, reads out the output current accumulated in the capacitor from when the reset signal is supplied until when the readout signal is supplied, wherein conductive wiring is provided along readout wiring that is for reading out the output current, the conductive wiring being connected to neither the photodetection element in the pixel region nor a pixel switching element of the pixel region.

2. The display device according to claim 1, wherein a unity-gain amplifier that causes a potential of the conductive wiring to be the same as a potential of the readout wiring is connected to the conductive wiring.

3. The display device according to claim 1, wherein an amplifier having a gain greater than I in order to cause a potential of the conductive wiring to be the same as a potential of the readout wiring is connected to the conductive wiring.

4. The display device according to claim 1, wherein the readout wiring also serves as a source line that supplies an image signal to the pixel switching element of the pixel region.

5. The display device according to claim 1, wherein the sensor switching element is an amorphous silicon TFT or a microcrystalline silicon TFT.

6. The display device according to claim 1, wherein the photodetection element is a phototransistor.

7. The display device according to claim 6, wherein the photodetection element is an amorphous silicon TFT or a microcrystalline silicon TFT.

8. The display device according to claim 6, wherein a gate and a source of the photodetection element are connected to the reset signal wiring.

9. The display device according to claim 6, wherein the reset signal wiring is connected to a gate of the photodetection element, and second reset signal wiring that causes a potential drop after the photodetection element has entered an off state is connected to a source of the photodetection element.

10. The display device according to claim 1, further comprising:
a common substrate opposing the active matrix substrate; and
liquid crystal sandwiched between the active matrix substrate and the common substrate.
